(19) United States
(12) Patent Application Publication
(10) Pub. No.: US 2004/0225545 A1
(43) Pub. Date: Nov. 11, 2004

(54) System and method for offering unsecured consumer credit transactions

(76) Inventors: James E. Turner, Tampa, FL (US); Jason Brooks, Tampa, FL (US); Lee Brooks, Chapel Hill, NC (US)

Correspondence Address: FOLEY & LARDNER, 321 NORTH CLARK STREET, SUITE 2800, CHICAGO, IL, 60610-4764, US

(21) Appl. No.: 10/434,129

(22) Filed: May 8, 2003

(51) Int. Cl. G06F 17/60

(52) U.S. Cl. 705/8

(57) ABSTRACT

A payday loan system is provided. An employee is issued a stored value card. The employee's wages are direct deposited to the stored value card. The holders of the stored value card are provided with advances on future wages. The payroll cycle is tracked so that collection is triggered on the pay date. The stored value card account is accessed for the purpose of collecting repayment of the advance. After an employer makes a regular payroll deposit, the amount of the advance is collected.

### FIELD OF THE INVENTION

The present invention relates to consumer credit.

### BACKGROUND OF THE INVENTION

In the mid-1990s, banking deregulation and the exit of sub-prime markets by traditional banks created a need for credit facilities for people who did not qualify or want traditional lending instruments. (Gregory Elliehausen & Edward Lawrence, Payday Advance Credit in America: An Analysis of Customer Demand, Monograph #35, Credit Research Center, McDonough School of Business, Georgetown University, April 2001). The departure of traditional credit providers gave rise to the so-called payday lending institutions. A typical payday lending institution offers two loan models. In the first, the institution requires a customer to present a post-dated check for the amount of the loan and applicable fees and interest. The institution makes loans available to the customer via automated clearinghouse (ACH) to a bank account, check or in some cases cash. Collection occurs when the institution deposits a post-dated check. In the second model, a short-term loan is made that requires bank account ACH information to facilitate collection. The institution (retail or Internet) will deposit the amount of advance into customer's account via ACH direct deposit.

It is estimated that there are in excess of 20,000 check cashing and payday loan locations around the country. (Jean A. Fox & Edmund Mierzwinski, Rent-A-Bank Payday Lending, Consumer Federation of America, November 2001) According to an industry study, banked employees initiated over 65 million payday loan transactions in 2001. (Gregory Elliehausen & Edward Lawrence, Payday Advance Credit in America: An Analysis of Customer Demand, Monograph #35, Credit Research Center, April 2001). According to the same industry study, the typical payday loan customer has the following demographic characteristics:

65% renters; 20% owned home; 15% other.

66% less than 45 years old.

Average gross income $24,673 (with 19% less than $15,000 and 12% greater than $40,000).

Employed at same job for approximately 4 years.

Completed high school and some college.

These payday loans, however, come at a steep price. Given the risks and associated costs, nationally payday lenders have an average interest and fee of about $18.28 for $100.00 borrowed for up to 2 weeks. This is over 18% of the face value of the loan in interest and fees, resulting in many cases in an annual interest rate of over 450%. (Jean A. Fox & Edmund Mierzwinski, Rent-A-Bank Payday Lending, Consumer Federation of America, November 2001).

In addition, as many as 25 million Americans have no access to banking products, i.e., credit, checking, or similar facilities (Ron Leuty, Visa Pushes Payroll Card To Reel In The ‘Unbanked’, San Fran. Bus. T., Apr. 26, 2002), and approximately 40 million Americans do not use mainstream banking services. (Shelia Bair, Remarks at Consumer Bankers Association Forum, Mar. 8, 2002, at www.cbanet.org). These unbanked employees generally cash their check at a check cashing location, a bank, or merchant, incurring expenses and inconvenience.

Since payday loan programs require the customer to write a post dated check or rely on ACH system, only banked employees have access to check advance programs. In addition to a bank account, payday lenders typically place requirements on customers such as having a drivers license, being on the job for a minimum amount of time such as, for example, 3 months, and earning a minimal income such as, for example, $1,000 per month. Thus, for example: “ . . . around 40% of families who have been involved with the welfare system are unbanked and, therefore, cannot obtain a payday loan.” (Michael A. Stegman & Robert Faris, Payday Lending: A Business Model that Encourages Chronic Borrowing, Econ. Dev. Q., (forthcoming) available at http://www.-unc.edu/depts/pubpol/picy260spr03.htm, page 13). Since most payday lenders do not provide credit to customers without a bank account, the unbanked employed population is forced to select from secured credit card products, pawn shop (secured) loans or does not qualify (lack of bank account).

This situation results in costs for employees and employers alike. A typical payroll check can cost an employer approximately $1.07 to issue, while the cost to directly deposit employees' net pay to an account costs approximately $0.05 a transaction. (John Hall, ATM Payroll Accounts: Company Savings, Worker Convenience, Tampa Tribune, Apr. 25, 2002). For the average employer, direct deposit represents savings of over $65 per employee per year. (Federal Reserve Bank of Atlanta at www.direct-deposit.org, (stating that $1.25 per weekly payment based on 52 payments to the employee per year, but excluding payroll distribution costs)). In large urban areas, surveys indicate that somewhere between 20% and 40% of the unbanked employees pay fees to cash their paychecks and many of these patronize commercial check-cashing outlets. (John Caskey, Bringing Unbanked Households Into the Banking System, January 2002, at www.brook.edu-/dybdocroot/es-/urban/capitalxchange/article10.htm). In addition to these costs, many employers are confronted with employees who seek a short-term loan, as an advance against their upcoming paycheck. The employer has the choice of saying “no”, risking losing an employee, or saying “yes” and becoming a lending institution.

What is thus needed is method and system for providing economical credit services to employees. Such method and system should be capable of providing credit services to both the banked and the unbanked. Such method and system should preferably allow employers to obtain the benefits of direct deposit for both banked and unbanked employees. Such method and system should be economical and convenient not only to the employer but also to the employee.

### SUMMARY OF THE INVENTION

A method and system in accordance with the principals of the present invention provides economical credit services to employees. A method and system in accordance with the principals of the present invention is capable of providing credit services to both the banked and the unbanked. A method and system in accordance with the principals of the present invention preferably allows employers to obtain the benefits of direct deposit for both banked and unbanked employees. A method and system in accordance with the principals of the present invention is economical and convenient not only for the employer but also for the employee.

A payday loan system is provided. An employee is issued a stored value card. The employee's wages are direct deposited to the stored value card. The holders of the stored value card are provided with advances on future wages. The payroll cycle is tracked so that collection is triggered on the pay date. The stored value card account is accessed for the purpose of collecting repayment of the advance. After an employer makes a regular payroll deposit, the amount of the advance is collected.

### BRIEF DESCRIPTION OF THE DRAWINGS

FIG. 1 is a flowchart showing a customer interaction routine.

FIG. 2 is a flowchart showing the user authentication routine.

FIG. 3 is a flowchart showing the main menu routine.

FIG. 4 is a flowchart showing a customer advance verification routine.

FIG. 5 is a flowchart showing the customer history subroutine.

FIG. 6 is a flowchart showing the maintenance subroutine.

FIG. 7 is a flowchart showing the advance request routine.

FIG. 8 is a flowchart showing the customer credit limit determination routine.

### DETAILED DESCRIPTION OF THE INVENTION

Employers who will be most attracted to the present invention operate in service or labor-intensive industries and have a minimum number employees. Examples of particular industries that might be particularly attracted include manufacturing, hospitality, automotive services, maintenance construction, telemarketing agriculture, and janitorial services. Such employers face frequent requests from employees for advances. Faced with requests for employee advances, a typical manager may be reluctantly forced into the personal life of his or her employees when they approach him for some extra money until their next paycheck. This scenario creates at best an uncomfortable situation between the employer and employee. Employee advances also create an administrative burden for the employers' human resource department. Finally, such advances cast the employer into the role of a lender, making their capital available for employees' loans.

With the present invention, employers are able to market to employees that they have access to short-term cash at competitive rates as a direct result of their employment, which can be a strong selling point to employees, particularly on the initial recruitment. In addition, the present invention offers increases in employee productivity since employees who might otherwise have spent the better part of the day worrying about a financial emergency and trying to borrow some money from their supervisor or co-workers, can now focus on their work assignments.

Through use of the present invention, employers gain the further advantages of implementing an electronic payroll system, thereby reducing check distribution headaches and realizing the cost savings from processing a payment electronically via the direct deposit process.

Stored value cards have emerged as an attractive way of providing employers and employees with the advantages of direct deposit. Although some variation of stored value cards have been available in niche markets, earlier stored value cards were not readily accepted because the stored value cards were difficult to use, and were limited to selected industries. For example, the InstaPay program from Concord EFS, 2525 Horizon Lake Drive, Suite 120, Memphis, Tenn. 38133 targeted truck drivers only and significantly limited the availability of funds. The evolution of the stored value cards now has reached a point where it can overcome the initial impediments to its acceptance. Evidence of the increased popularity and acceptance of stored value cards is the decision by Sears, Roebuck and Co., 3333 Beverly Road, Hoffman Estates, Ill. 60179 to offer stored value cards to its US employees. (Press Release, Comdata: Providing Paperless Payday Option for Sears Employees, Jul. 16, 2002).

The present invention allows employers to apply stored value cards for employees with and without banking relationships to obtain convenient access to their wages without the high costs of check-cashing services. The present invention allows employers to offer direct deposit of wages and salary to employees who do and do not have banking relationships through a stored value card. The present invention allows employers to apply stored value cards as a solution for employees without banking relationships to obtain convenient short-term credit.

The principals of the present invention can be implemented by the employer itself or by a third party service provider to the employer. In addition, the principals of the present invention can be implemented by a singular entity or with the cooperation of existing service providers who offer competitive advantages in providing different aspects of the present invention. In a preferred embodiment of the present invention, a third party provider to employers can utilize several existing service providers who offer a competitive advantage in the issuance and processing of stored value cards and payroll cards, direct deposit payroll systems and the management of short term loans.

In accordance with the present invention, an employer sends normal net pay to an employee's stored value card via ACH direct deposit process. The employee's stored value card represents an account at a depository institution, such as, for example in one embodiment BankFirst Corporation, Inc., 3817 S. Elmwood, Sioux Falls, S.Dak. 57105. In a preferred embodiment of the present invention, WildCard Systems, Inc., 1601 Sawgrass Corporate Parkway, Suite 300, Sunrise, Fla. 33323 can be utilized as a third party issuer and processor of stored value cards and payroll cards. Holders of the stored value card may access their funds through automated teller machines (“ATMs”). In addition, holders of the stored value card can use the card as a debit card for merchant transactions. The use of the term “debit card” herein is intended in its broadest sense, including but not limited to cards where the user has the option to conduct a personal identification number (PIN) based debit transaction or a signature credit transaction.

Short-term consumer credit may be accessed through the stored value card by providing holders of a stored value card with the opportunity to obtain advances on future wages. The advance may be deposited directly onto the employee's stored value card or to be advanced as a check. On the next pay period, the employee's stored value card account is accessed for the purpose of collecting repayment of the advance and associated fees. Both the credit decision and funds can be made available via an employee's stored value cards in real-time.

A key aspect of the present invention is in managing the risks of non-payment. As previously described, payday loans of the prior art come at a steep price, typically over 18% of the face value of the loan in interest and fees, resulting in many cases in an annual interest rate of over 450%. (Jean A Fox & Edmund Mierzwinski, Rent-A-Bank Payday Lending, Consumer Federation of America, November 2001). Payday loan companies utilize 3^{rd} party credit services to identify potential credit risks as well as customers frequenting multiple locations in a short period of time. Some states maintain databases of customer frequency and require locations to check this database before approving an advance. Nevertheless, payday advance companies experience with debtor default varies with bad debt rates of about 11% being most common. (State of Colorado Department of Law, 2001 Deferred Deposit Lenders Supervised Lenders' Annual Report available at http://www.ago.state.co.us-/UCCC/annrep/ddlannrpt2001.pdf). In addition, credit card companies cite bad debt rates of between 12 to 20% of their portfolio. (Providian Annual Report, 2002. Providian Financial Corporation, 201 Mission St., San Francisco, Calif. 94105 http://www.providian.com/annual/pdf/-pvn_{—}2002_ar2.pdf). This is in contrast to mainstream banks that have bad debt rates of around 1.0%. (Meredith Jordan, Bad Loans Up at SunTrust, Atlanta. Bus. Chron., available at http://atlanta.bizjournals.-com/atlanta/stories/2003/03/17/story2.html).

Several features of the present invention help to manage the risks of non-payment. Managing the stored value card in accordance with the present invention ensures direct collection immediately after employer makes a regular payroll deposit. Managing the stored value card in accordance with the present invention schedules collection date based on date payroll is deposited (including holiday adjustments forward/backwards when banks are closed due to federal holidays). By scheduling collection for the actual payday (rather than self-reported payday, a default number of days or “next Friday”), the probability of collection increases significantly. Managing the stored value card in accordance with the present invention offers residual protection in the event of a termination as there is a delay from the end of a payroll cycle and actual payment to the employee.

Records for terminated or reduced hours employee are identified and updated. This in turn reduces the credit limit. Each credit limit is defined based on previous wages, industry information, customer history, as well as several data points from the employer (turnover, payroll schedule, average wage, etc.). Data is gathered from self-completed reports, industry and similar external data, as well as weighing experience and each data source when being considered for a decision. Collection of funds is automated and facilitated by access to payroll funds as they are deposited to stored value card accounts. An example system of the present invention (described below) achieved a 0.92% bad debt rate.

An example system in accordance with the principals of the present invention is described. The example system of the present invention uses a web server and application server to deliver information from users to management. The example system has based its database application on Oracle 91 available from Oracle Corporation, 500 Oracle Pkwy, Redwood City, Calif. 94065-1677. The web and application server use a supported version of Linux operating system. Linux is an operating system that is available under a general public license. See, for example, http://www.linux.org/. The web component uses the standard Extensible Markup Language (XML) dataset for financial institutions and Java based applications where appropriate. Java is licensed by Sun Microsystems, Inc., 4150 Network Circle, Santa Clara, Calif. 95054.

The example system of the present invention automatically processes a request for an advance. The advance is approved or declined based on business rules taking into account factors such as, for example: Current employment?—obviously a no causes a decline; request exceeds credit limit?—credit limit continues to improve—in a preferred embodiment the most recent net pay to our card is reviewed with an sliding weight on the more recent deposits; employer turnover (as reported, by SIC and similar industry and benchmarks (as observed); cardholder history (advances taken and paid, any late events); strong downward swings in pay (for example, pay drops by 50%); unusual events (holiday or employer specific events (for example, closed for inventory)); environmental effects (for example weather for construction); frequency of advances and similar usage patterns both at the cardholder and at the employer (for example, a high spike in requests from a specific employer in a specific range of zip codes would cause a flag); address, age, ID (security word, social, or similar) verification; and average wage. The example system continues to revise and reevaluate decisions based on additional data acquisition. The example system provides for near-real time to real-time availability of approved funds, if the employee requests to have payment to the card rather than a paper check. Database increases the available balance on a respective cardholder's account. Automated collection tracks the payroll cycle and loads to a card so that the collection event is triggered on next payroll. The example system automatically deducts the funds (in real-time) from the cardholder's account. The example system includes real time monitoring for pattern identification such as possible fraudulent transaction and projecting daily and weekly loan activity for cash flow management.

The example system begins with an agreement with a sponsoring employer to manage the payroll card system. Under this employer-sponsored program, employees enter into three agreements: an agreement with a participating depository institution to establish the account and issue the stored value card; an agreement with an issuer and processor of stored value cards and payroll cards for card management services; and an agreement with a credit provider for availability of employee advances.

Employee advances are expected to fall within a range, for example of $100 to $500, based on the employee's salary history. The term of the employee advance is usually until the following payday, typically one week. Generally, the employee is issued the stored value card upon being hired and the employer begins directing payroll to the card via the direct deposit process. The employer direct deposits the cardholder's compensation to the cardholder's account and gives notice immediately upon changes in employment status.

The stored value card can operate on an existing network for ATMs and Point of Sale merchants. For example, the MasterCard network offered by MasterCard International, 2000 Purchase Street, Purchase, N.Y. 10577 U.S.A. offers over 30 million locations where a stored value cardholder can access their funds. (MasterCard Corporate Fact Sheet, at http://www.mastercardintl .com/newsroom/corp_fact.html). It is estimated that an average employee using the stored value card of the present invention will save $6.00 per week in fees. This estimate is based on an average of $400.00 in fees per year or an average of $7.69 a week; the average cardholder on a weekly payroll cycle would incur an average of $1.65 per week with the opportunity to be as low as $0.65 a week, thereby saving $6.04 per week. (John Caskey, Bringing Unbanked Households Into the Banking System, January 2002, at www.brook.-edu/dybdocroot/es-/urban/capitalxchange/article10.htm). This monetary savings is in addition to the time savings from not having to visit the bank or creditor directly to settle bills and the personal security issues of carrying cash. This timesaving can be significant as it is estimated that people spend as much as 24 hours a year in line waiting to cash their paycheck. (American Payroll Association, Direct Deposit White Paper, Fall 1998, available at www.americanpayroll.org/wp103.html).

Upon termination, the stored value card remains active unless there is no activity for a given time period, such as for example 90 days. Once entered into the system, the employee can take the stored value card to a new employer and, using the direct deposit process, an employer can deposit payroll funds as if it were a regular direct deposit account.

In a preferred embodiment, a web interface is available for all card management functions. While some cardholders will have at least limited Internet access, the majority of customers will use a telephone to interact. Consequently, in a preferred embodiment an automated telephone interface is also provided. It is expected that the automated telephone interface will address approximately 85% of calls, with approximately 90% of the calls handled by the automated system being requests by an employee for an advance and approximately 10% of the calls handled by the automated system being checks on account balances. Customer service representatives (CSRs) will handle the remaining approximately 15% of calls that require interactive response.

Typical interactions with a CSR include dealing with a card holder who has been declined an advance, hoping to override or question the decision or a card holder trying to delay repayment to a following pay cycle. These scenarios are all available to the CSR in predefined scripts and last anywhere from 1 to 4 minutes with the average being 2.1 minutes. An occasional call will be escalated to management to reiterate the written policy to the cardholder.

Given the sensitivity of the data as well as the possibility that a natural disaster or similar event could interrupt the ability to service existing and new customers, backup and recovery procedures will be implemented. In a preferred embodiment, all information is to be sent to an off-site secure location on at least a daily basis. Further, in a preferred embodiment the card processor maintains a fully operational real-time processing system in a separate location.

The card issuance process consists of two components: (1) the initial conversion where all existing employees wanting to migrate to the stored value card are enrolled and (2) the issuance of the stored value card to new hires. As part of the initial conversion, the employer is provided with informational brochures and posters for informational marketing (to potential cardholders) by explaining usage and answering common questions about the program. Employers are given an inventory of cards for “instant issue” for newly hired employees.

The issuance of the stored value cards, involves several steps. Employees complete and sign three applications: (i) one for card usage and management which indicates the card number issued to this employee, (ii) one for employee advances, and (iii) one for establishment of the account and issuance of the stored value card. Employer issues the stored value card to employee. Applications are received and processed. The stored value card is then activated.

The process by which an employee advance is issued to the holder of an stored value card has several steps. The cardholder provides card number and authentication via telephone or the Internet. The cardholder requests an advance. Every loan decision is run through a set of criteria and fraud identification parameters in order to provide a credit decision. The request is processed and an approval or decline is returned based on predefined logic. Given an approval, the approval is relayed to the cardholder. The cardholder makes a decision as to the means by which they wish to receive advanced funds. The alternatives available are (1) a paper check sent to their address of record or (2) instant availability on their stored value card. Given a request for instant availability on their stored value card, a handshake is initiated via an array-to-array interface authorizing the instant funding of the loan request to the respective card holders account. The funds are maintained on deposit with depository institution and settled nightly.

At the time an advance is made, the payback date is predetermined, based on the pay schedule of the cardholder's employer. The day before an advance comes due, it is included on an automated batch file for processing. The file is cued that evening as payroll funds are received via the ACH process and appropriate deductions are made to cardholder's accounts. Collected funds are settled nightly.

The employer is required to give immediate notification upon employees' termination. This allows time to collect outstanding advances, fees, and to terminate employees' access to additional advances. All termination information is processed in a real-time environment with a high-priority.

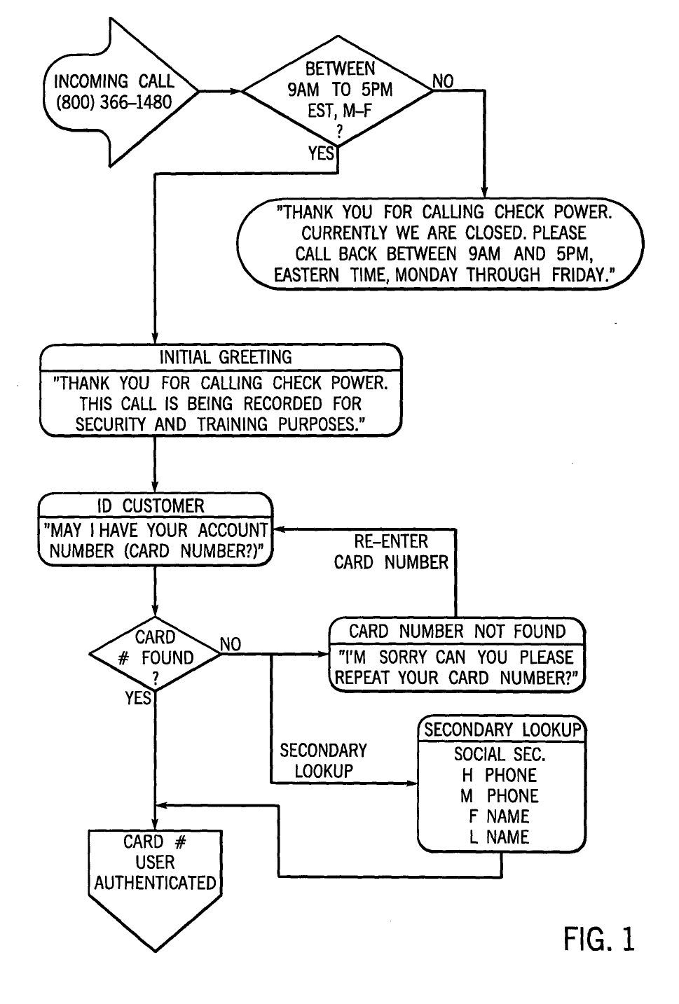

Referring now to the Figures, an example process in accordance with the principals of the present invention is described. Referring to FIG. 1, a flowchart showing a customer interaction routine is seen. Initially, the customer contacts the system by, for example, connecting via the Internet or calling a toll free telephone number. Then, the customer is queried as to the customer's identification/card number. The identification/card number is checked. If the identification/card number is not found, a recording requests the customer re-enter the customer's identification/card number. The identification/card number is checked. If the identification/card number is not found a second time, a secondary look based on secondary identification factors such as for example the customer's social security number, home phone, or name is initiated.

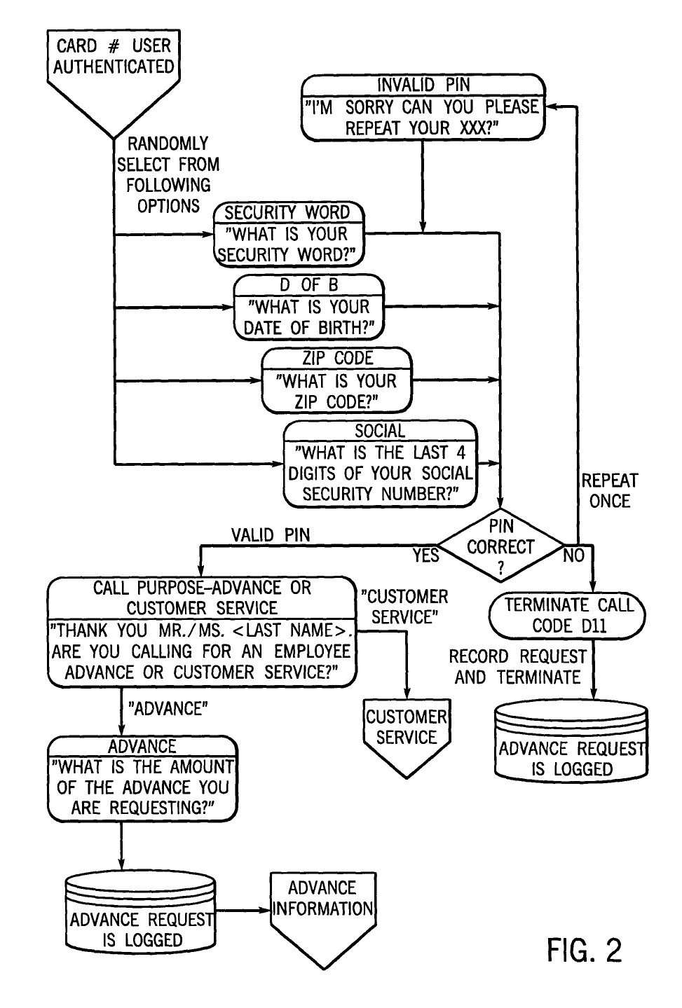

If the identification/card number is found, the customer proceeds to the user authentication routine. Referring to FIG. 2, a flowchart showing the user authentication routine is seen. The system initially randomly selects a security inquiry from a plurality of options. In a preferred embodiment, the security inquiry options are a customer pre-selected security word, the customer's date of birth, the customer's zip code and the last four digits of the customer's social security number. If the customer responds incorrectly to the security inquiry the system requests the customer to re-enter the response. If the customer again responds incorrectly to the security inquiry the process is terminated.

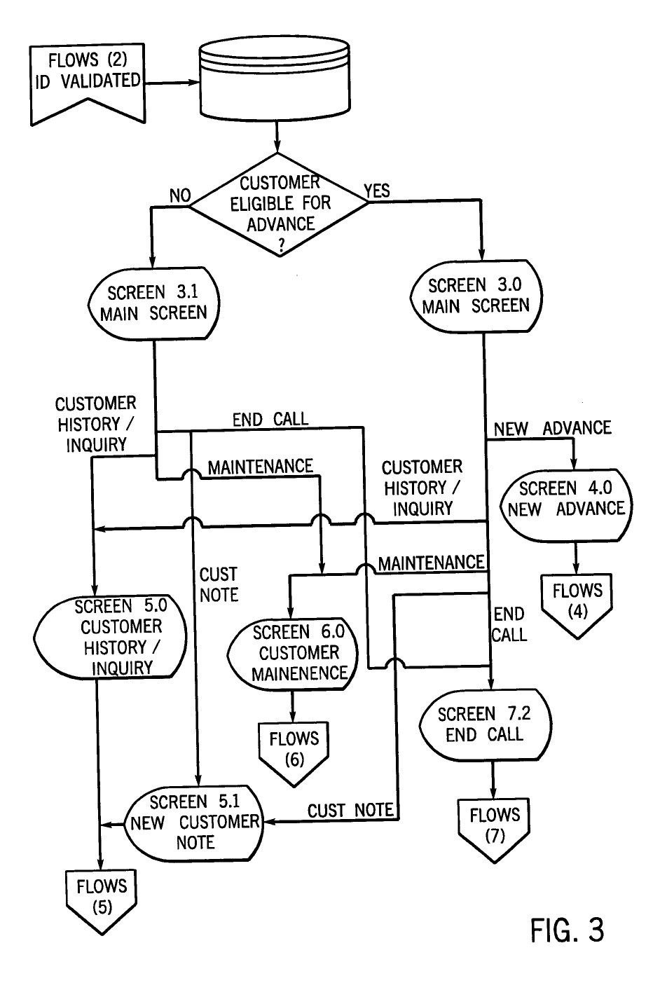

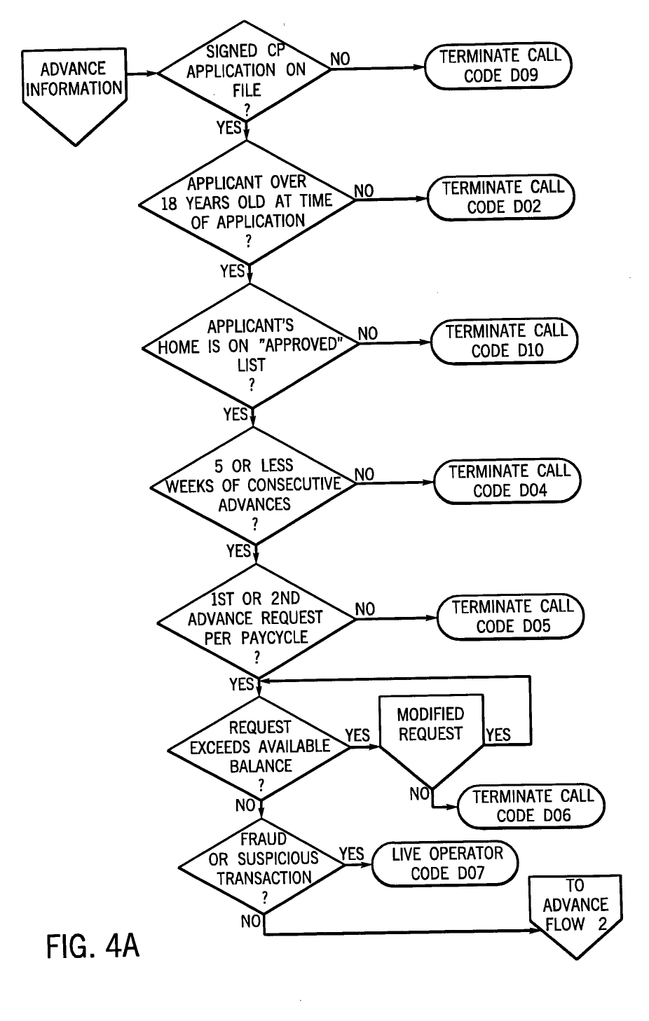

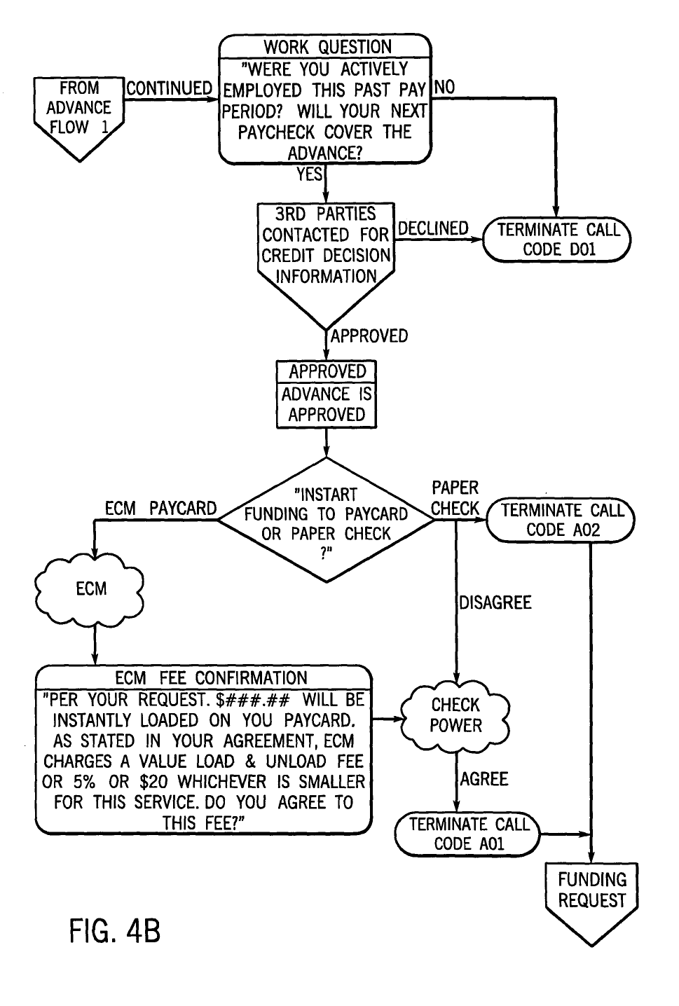

Once the customer is authenticated the home screen is displayed. Referring to FIG. 3, a flowchart showing the main menu routine is seen. Initially, whether the customer can obtain an advance is determined. Referring now to FIG. 4, a flowchart showing a customer advance verification routine is seen. Initially, whether the customer has a signed application on file is determined. If the customer does not, the process is terminated. If the customer is, whether the customer is over 18 years of age is determined. If the customer does not, the process is terminated. If the customer does, whether the customer's home is in a territory covered by the system is determined. If the customer home is not, the process is terminated. If the customer's home is, whether the customer has 4 or less consecutive advances is determined. The purpose of this step in this embodiment is to preclude an employee from perpetually using the advance feature. If an employee calls for an advance four consecutive pay cycles, after the fourth time the employee is forced to wait a full cycle before becoming eligible for a further advance. This ensures they are paid back in full and get caught up on their paycheck. If the customer does not have 4 or less consecutive advances, the process is terminated. If the customer does, whether this is the first advance request per pay cycle is determined. The purpose of this step in this embodiment is to preclude an employee from taking more than one advance in a pay cycle. If it is not the first advance request in the pay cycle, the process is terminated. If it is the first advance request, whether the advance request exceeds the available balance is determined. If it does, the customer is asked to modify the advance request. If the customer does not modify the advance request the process is terminated. If the customer does modify the advance request whether the modified advance request exceeds the available balance is determined.

When the advance request or modified advance request does not exceed the available balance, the transaction is analyzed as to whether a high probability that it is a fraudulent or suspicious transaction is determined. If the transaction is flagged, a live operator takes the incoming inquiry. If the transaction is not flagged, the customer is queried as to whether the customer has been actively employed during the last pay period and whether the customer's next paycheck will cover the amount of the advance. If not, the process is terminated. If the customer responds affirmatively, a third party credit agency is contacted to conduct a credit analysis as known in the art. If the customer fails the credit analysis, the process is terminated. If the customer passes the credit analysis, the customer is approved.

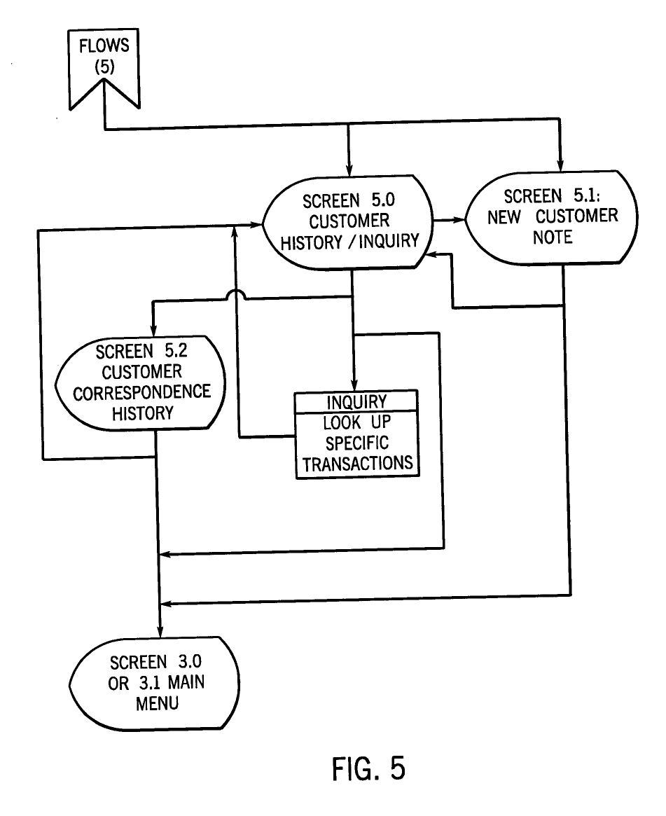

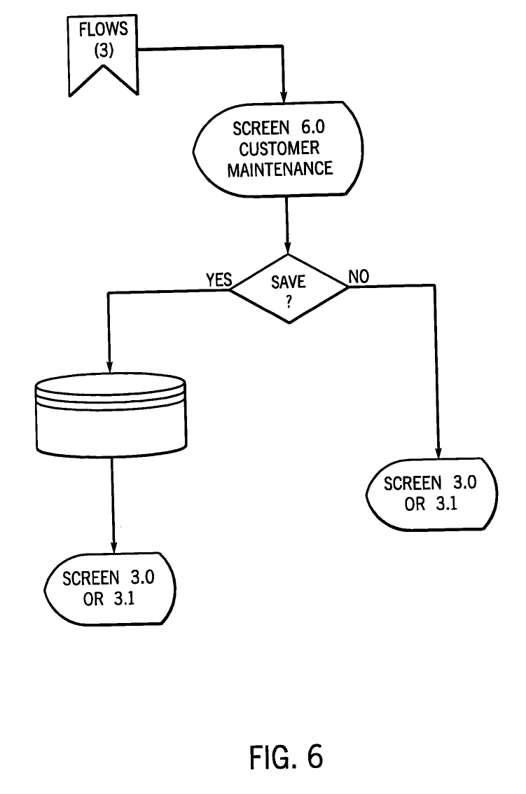

If the customer cannot obtain an advance, the customer is provided with the option of ending the session, entering customer history or entering maintenance. Referring to FIG. 5, a flowchart showing the customer history subroutine is seen. Customer history provides the customer with detail of the customer's advances. The customers can review customer correspondence history or look up specific transactions. A new customer note is provided for new customers. Referring to FIG. 6, a flowchart showing the maintenance subroutine is seen. Maintenance allows the customer to update customer information such as for example address and phone number.

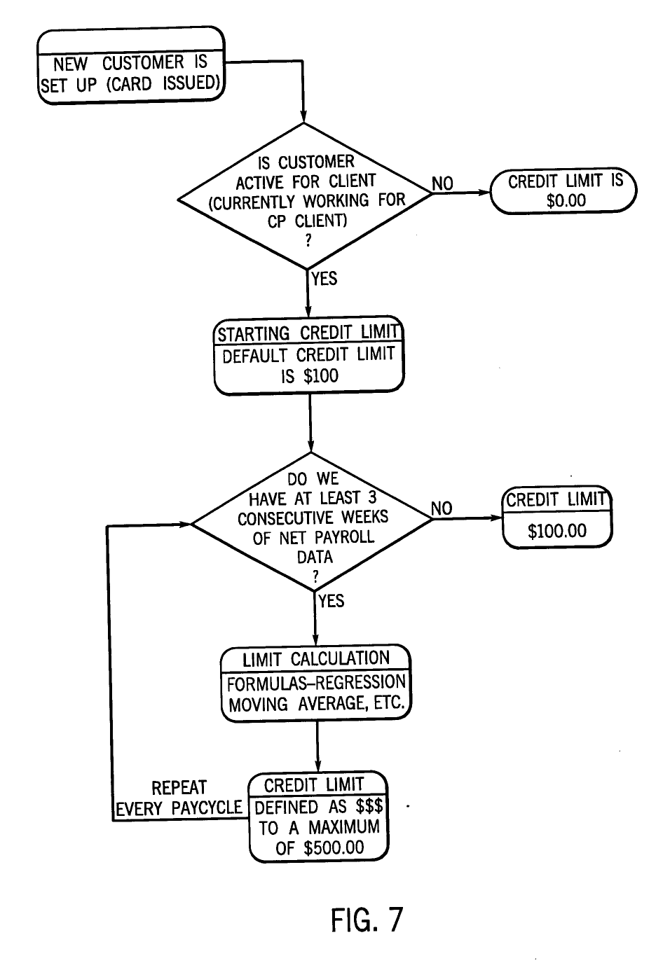

If the customer can obtain an advance, the customer is provided with the option of ending the session, entering customer history, entering maintenance or obtaining an advance. Referring to FIG. 7, a flowchart showing the advance request routine is seen. If an advance is requested, the customer is queried as to the amount of the advance. If the amount requested is either below a default credit limit or above a customer specific maximum credit limit, the customer is asked to revise the amount requested. Whether the customer can obtain an advance is determined. If the customer cannot obtain an advance, a script so informs the customer and the process is terminated. If the customer can obtain an advance, a customer credit limit determination routine is provided.

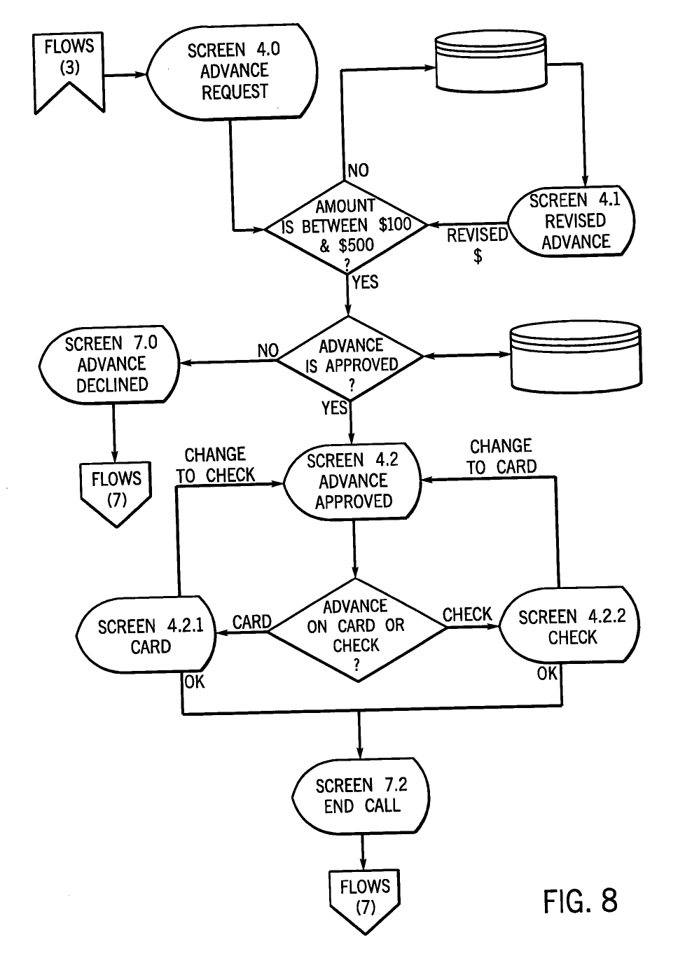

Referring to FIG. 8, a flowchart showing the customer credit limit determination routine is seen. Initially, the customer is checked to see if the customer is currently working for the subscribed employer. If not, then no credit limit will be extended. If the customer is employed, a default credit limit is established. In one embodiment, the default credit limit can be $100. Then, the customer is checked to determine whether the customer has been employed for at least three consecutive weeks. If not, then the default credit limit is the customer's credit limit. If the customer has been employed at least three consecutive weeks, then a new credit limit is calculated for that customer. The new credit limit is between the default credit limit and a maximum credit limit. In one embodiment, the maximum credit limit can be $500. For each pay cycle, the customer credit limit determination is repeated. Referring back to FIG. 7, if the new credit limited exceeds the customer's requested advance, the system informs the customer to revise the amount requested.

Once approved, the customer is informed. The customer is queried as to whether the advance is to be forwarded via check or added to the customer's stored value card. The customer's selection is verified. If the customer selects a check, a check is issued and sent to the customer and the process is terminated. If the customer selects stored value card, the system electronically adds the advance to the card and the process is terminated.

While an exemplary process in accordance with the principals of the present invention has been described with reference to the Figures, it should be appreciated that of course the use of different, additional or less routines, subroutines, steps and different combinations thereof are to be considered within the scope of the present invention

### EXAMPLE

A test of the present invention, programs was conducted with Gulfside Supply, Inc., 501 N. Reo Street, Tampa, Fla. 33609, a Florida-based roofing and metal distributor with 220 employees and Jiffy Management Company, Inc., 11708 Abercorn Extension, Savannah, Ga. 31419. Initially 75 cards were issued to 2 clients with employees in 4 states. In the 1^{st} week of November, employees began to receive payroll funds directly onto their card. Immediately following the first payroll cardholders became eligible for Check Power Employee Advances. A third entity, LV Thompson, Inc. 2103 E. 2^{nd} Avenue, Tampa, Fla. 33605, implemented the program (paycard and employee advances) in early January 2003. In these tests, “each card generated an average of 2 advances (8 advances on an annualized basis). The average advance was $152.45

While the invention has been described with specific embodiments, other alternatives, modifications and variations will be apparent to those skilled in the art. For example, while the preferred embodiment of the present invention utilizes stored value cards, other methods are to be considered within the scope of the present invention. For example, the principals of the present invention could be applied to a payroll service or similar with the following conditions pursuant to which payment is made available via stored value card, an ACH to an existing account, or similar access method; the present invention is available to all employees. Accordingly, all such alternatives, modifications and variations are intended to be included within the spirit and scope of the appended claims.

What is claimed is:

1. An electronic payroll system comprising:
issuing a stored value card;
direct depositing wages to the stored value card; and
providing holders of the stored value card with advances on future wages.

2. The electronic payroll system of claim 1 further including an employer administering the system.

3. The electronic payroll system of claim 1 further including a third party administering the system.

4. The electronic payroll system of claim 1 further including a third party providing issuance of the stored value card.

5. The electronic payroll system of claim 1 further including a third party providing processing of the stored value card.

6. The electronic payroll system of claim 1 further including a third party providing a direct deposit system.

7. The electronic payroll system of claim 1 further including a third party providing a payroll advance loan.

8. The electronic payroll system of claim 1 further including sending wages to an employee's stored value card via automated clearinghouse direct deposit process.

9. The electronic payroll system of claim 1 further including accessing stored value card funds through automated teller machines.

10. The electronic payroll system of claim 1 further including using the stored value card as a debit card for merchant transactions.

11. The electronic payroll system of claim 1 further including depositing the advance directly onto the stored value card.

12. The electronic payroll system of claim 1 further including advancing the funds as a check.

13. The electronic payroll system of claim 1 further including accessing on the next pay period the stored value card account for the purpose of collecting repayment of the advance.

14. The electronic payroll system of claim 1 further including collecting immediately after an employer makes a regular payroll deposit.

15. The electronic payroll system of claim 1 further including scheduling collection based on the date payroll is deposited.

16. The electronic payroll system of claim 1 further including defining a credit limit based on factors selected from the group comprised of previous wages, industry information, customer history and combinations thereof.

17. The electronic payroll system of claim 1 further including defining a credit limit based on factors selected from the group comprised of employee turnover, payroll schedule, average wage and combinations thereof.

18. The electronic payroll system of claim 1 further including automatically tracking a payroll cycle so that collection is triggered on a next payroll.

19. The electronic payroll system of claim 1 further including monitoring for pattern identification of a fraudulent transaction.

20. The electronic payroll system of claim 1 further including projecting daily and weekly loan activity for cash flow management.

21. The electronic payroll system of claim 1 further including interfacing via the Internet.

22. The electronic payroll system of claim 1 further including interfacing via a telephone.

23. The electronic payroll system of claim 1 further including running an advance request through a set of criteria.

24. The electronic payroll system of claim 1 further including running an advance request through a set of fraud identification parameters.

25. A payday loan system comprising:
issuing an employee a stored value card;
direct depositing the employee's wages to the stored value card;
providing the employee with an advance on future wages; and
accessing on or after a pay period the stored value card for the purpose of collecting repayment of the advance.

26. The payday loan system of claim 25 further including an employer administering the system.

27. The payday loan system of claim 25 further including a third party administering the system.

28. The payday loan system of claim 25 further including a third party providing issuance of the stored value card.

29. The payday loan system of claim 25 further including a third party providing processing of the stored value card.

30. The payday loan system of claim 25 further including a third party providing a direct deposit system.

31. The payday loan system of claim 25 further including a third party providing the advance.

32. The payday loan system of claim 25 further including sending wages to the stored value card via automated clearinghouse direct deposit process.

33. The payday loan system of claim 25 further including accessing stored value card funds through an automated teller machine.

34. The payday loan system of claim 25 further including using the stored value card as a debit card.

35. The payday loan system of claim 25 further including depositing the advance directly onto the stored value card.

36. The payday loan system of claim 25 further including advancing the funds as a check.

37. The payday loan system of claim 25 further including scheduling collection based on the date payroll is deposited.

38. The payday loan system of claim 25 further including defining a credit limit based on factors selected from the group comprised of previous wages, industry information, customer history and combinations thereof.

39. The payday loan system of claim 25 further including defining a credit limit based on factors selected from the group comprised of employee turnover, payroll schedule, average wage and combinations thereof.

40. The payday loan system of claim 25 further including automatically tracking a payroll cycle so that collection is triggered on a next payroll.

41. The payday loan system of claim 25 further including monitoring for pattern identification of a fraudulent transaction.

42. The payday loan system of claim 25 further including projecting daily and weekly loan activity for cash flow management.

43. The payday loan system of claim 25 further including interfacing via the Internet.

44. The payday loan system of claim 25 further including interfacing via a telephone.

45. The payday loan system of claim 25 further including running an advance request through a set of criteria.

46. The payday loan system of claim 25 further including running an advance request through a set of fraud identification parameters.

47. A payday loan system comprising:
direct depositing wages to an account;
providing employees with advances on future wages;
automatically tracking a payroll cycle so that collection is triggered;
accessing the account for the purpose of collecting repayment of the advance; and
collecting after an employer makes a regular payroll deposit.

48. The payday loan system of claim 47 further including an employer administering the system.

49. The payday loan system of claim 47 further including a third party administering the system.

50. The payday loan system of claim 47 further including a third party providing a direct deposit system.

51. The payday loan system of claim 47 further including a third party providing the advance.

52. The payday loan system of claim 47 further including advancing the funds as a check.

53. The payday loan system of claim 47 further including utilizing a stored value card as the account.

54. The payday loan system of claim 53 further including a third party providing issuance of the stored value card.

55. The payday loan system of claim 53 further including a third party providing processing of stored value cards.

56. The payday loan system of claim 53 further including sending wages to an employee's stored value card via automated clearinghouse direct deposit process.

57. The payday loan system of claim 53 further including accessing stored value card funds through automated teller machines.

58. The payday loan system of claim 53 further including using the stored value card as a debit card for merchant transactions.

59. The payday loan system of claim 53 further including depositing the advance directly onto the stored value card.

60. The payday loan system of claim 47 further including scheduling collection based on the date payroll is deposited.

61. The payday loan system of claim 47 further including defining a credit limit based on factors selected from the group comprised of previous wages, industry information, customer history and combinations thereof.

62. The payday loan system of claim 47 further including defining a credit limit based on factors selected from the group comprised of employee turnover, payroll schedule, average wage and combinations thereof.

63. The payday loan system of claim 47 further including monitoring for pattern identification of a fraudulent transaction.

64. The payday loan system of claim 47 further including projecting daily and weekly loan activity for cash flow management.

65. The payday loan system of claim 47 further including interfacing via the Internet.

66. The payday loan system of claim 47 further including interfacing via a telephone.

67. The payday loan system of claim 47 further including running an advance request through a set of criteria.

68. The payday loan system of claim 47 further including running an advance request through a set of fraud identification parameters.
